(19) United States
(12) Patent Application Publication
(10) Pub. No.: US 2021/0193064 A1
(43) Pub. Date: Jun. 24, 2021

(54) TIMING CONTROLLER, DISPLAY DEVICE AND DISPLAY DRIVING METHOD

(71) Applicants: BOE TECHNOLOGY GROUP CO., LTD., Beijing (CN); HEFEI XINSHENG OPTOELECTRONICS TECHNOLOGY CO., LTD., Anhui (CN)

(72) Inventors: Gen PIAO, Beijing (CN); Chunyang NIE, Beijing (CN); Ke DAI, Beijing (CN); Yongjun YOON, Beijing (KR)

(21) Appl. No.: 16/078,049

(22) PCT Filed: Jan. 4, 2018
(86) PCT No.: PCT/CN2018/070786

§ 371 Date: Aug. 21, 2018

(30) Foreign Application Priority Data
Apr. 14, 2017 (CN) 201710243862.0

(51) Int. Cl. G09G 3/36

(52) U.S. Cl. CPC G09G 3/3614; G09G 2320/0276; G09G 2320/0204; G09G 2320/0247; G09G 2310/08

(57) ABSTRACT

Embodiments of the present disclosure provide a timing controller, a display device, and a display driving method. The timing controller includes a first digital gamma correction circuit, a second digital gamma correction circuit, and a microcontroller. The microcontroller is configured to count output frames in response to receiving a video signal; determine, based on the counting, whether a current output frame needs to be data voltage polarity inverted; responsive to determining that the current frame needs to be data voltage polarity inverted, using a first digital gamma correction table read from the first digital gamma correction circuit to calculate corrected data voltages; responsive to determining that the current frame does not need to be polarity inverted, using a second digital gamma correction table read from the second digital gamma correction circuit to calculate corrected data voltages; and output the corrected data voltages to a display.

### CROSS REFERENCE TO RELATED APPLICATIONS

The present application is the U.S. national phase entry of PCT/CN2018/070786, with an international filing date of Jan. 4, 2018, which claims priority to Chinese Patent Application No. 201710243862.0, filed on Apr. 14, 2017, the entire disclosures of which are hereby incorporated by reference.

### TECHNICAL FIELD

The present disclosure relates to the field of display technologies, and in particular, to a timing controller, a display device, and a display driving method.

### BACKGROUND

Liquid crystal molecules used by a liquid crystal display (LCD) have the characteristics that the level of a data voltage applied to the liquid crystal molecules through a pixel electrode cannot be always fixed, otherwise the liquid crystal molecules may, due to their characteristics being destroyed, fail to deflect in response to a change in the electric field to produce different brightness. In order to avoid this situation, a typical measure is to divide the data voltage into two polarities (a positive polarity and a negative polarity). When the voltage of the pixel electrode is higher than the voltage of a common electrode, it has a positive polarity. When the voltage of the pixel electrode is lower than the voltage of the common electrode, it has a negative polarity. The deflection of the liquid crystal molecules can be changed by alternately changing the positive and negative polarities of the level of the data voltage, thereby protecting the liquid crystal molecules.

When a positive and negative polarity deviation of a gray scale voltage occurs in a thin film transistor (TFT) LCD panel, asymmetrical voltages between an odd frame and an even frame cause a DC residual. The liquid crystal may flicker after being affected by the DC residual for a long time. Therefore, the DC residual is among troublesome problems with the TFT-LCD.

### SUMMARY

According to an aspect of the present disclosure, a timing controller is provided comprising: a first digital gamma correction circuit, a second digital gamma correction circuit, and a microcontroller. The microcontroller is configured to count output frames in response to receiving a video signal; determine, based on the counting, whether a current output frame needs to be data voltage polarity inverted; responsive to a determination that the current frame needs to be data voltage polarity inverted, using a first digital gamma correction table read from the first digital gamma correction circuit to calculate corrected data voltages; responsive to a determination that the current frame does not need to be polarity inverted, using a second digital gamma correction table read from the second digital gamma correction circuit to calculate corrected data voltages; and output the corrected data voltages to a display.

According to some embodiments, the second digital gamma correction table is obtained by pre-adjusting data voltages so that the frame that does not need to be data voltage polarity inverted is consistent in brightness with two frames before and after.

According to some embodiments, the first digital gamma correction table is obtained by pre-adjusting data voltages to achieve a specified display effect.

According to some embodiments, the timing controller further comprises a digital gamma buffer. The digital gamma buffer is configured to read the first digital gamma correction table from the first digital gamma correction circuit and the second digital gamma correction table from the second digital gamma correction circuit, respectively, and to buffer the first digital gamma correction table and second digital gamma correction table.

According to some embodiments, the microcontroller is further configured to read the first digital gamma correction table or the second digital gamma correction table from the digital gamma buffer.

According to some embodiments, the microcontroller determining based on the counting whether the current output frame needs to be data voltage polarity inverted comprises: the microcontroller determining whether the current frame is a frame that does not need to be data voltage polarity inverted based on a preset polarity non-inversion period.

According to another aspect of the present disclosure, a display device is provided comprising a display and the timing controller as described above. The display is configured to display an image based on received corrected data voltages.

According to yet another aspect of the present disclosure, a display driving method is provided comprising: counting output frames in response to receiving a video signal; determining, based on the counting, whether a current output frame needs to be data voltage polarity inverted; responsive to a determination that the current frame needs to be data voltage polarity inverted, using a first digital gamma correction table read from a first digital gamma correction circuit to calculate corrected data voltages; responsive to a determination that the current frame does not need to be polarity inverted, using a second digital gamma correction table read from a second digital gamma correction circuit to calculate corrected data voltages; and outputting the corrected data voltages to a display.

According to some embodiments, the second digital gamma correction table is obtained by pre-adjusting data voltages so that the frame that does not need to be data voltage polarity inverted is consistent in brightness with two frames before and after.

According to some embodiments, the first digital gamma correction table is obtained by pre-adjusting data voltages to achieve a specified display effect.

According to some embodiments, the driving method further comprises: reading the first digital gamma correction table from the first digital gamma correction circuit, respectively; reading the second digital gamma correction table from the second digital gamma correction circuit; and buffering the first digital gamma correction table and second digital gamma correction table.

According to some embodiments, the driving method further comprises: reading the buffered first digital gamma correction table or second digital gamma correction table.

According to some embodiments, the determining, based on the counting, whether the current output frame needs to be data voltage polarity inverted comprises: determining, based on a preset polarity non-inversion period, whether the current frame is a frame that does not need to be data voltage polarity inverted.

### BRIEF DESCRIPTION OF THE DRAWINGS

FIG. 1 is a schematic diagram of periodic polarity inversion in the conventional art.

FIG. 2 is a schematic diagram of a timing controller in accordance with an embodiment of the present disclosure.

FIG. 3 is a schematic diagram of another timing controller in accordance with an embodiment of the present disclosure.

FIG. 4 is a schematic diagram of a display device in accordance with an embodiment of the present disclosure.

FIG. 5 is a flowchart of a display driving method according to an embodiment of the present disclosure.

### DETAILED DESCRIPTION

Embodiments of the present disclosure will be described in detail below with reference to the accompanying drawings. It should be noted that, in the case of no conflict, the features in the embodiments and the embodiments in the present application may be arbitrarily combined with each other.

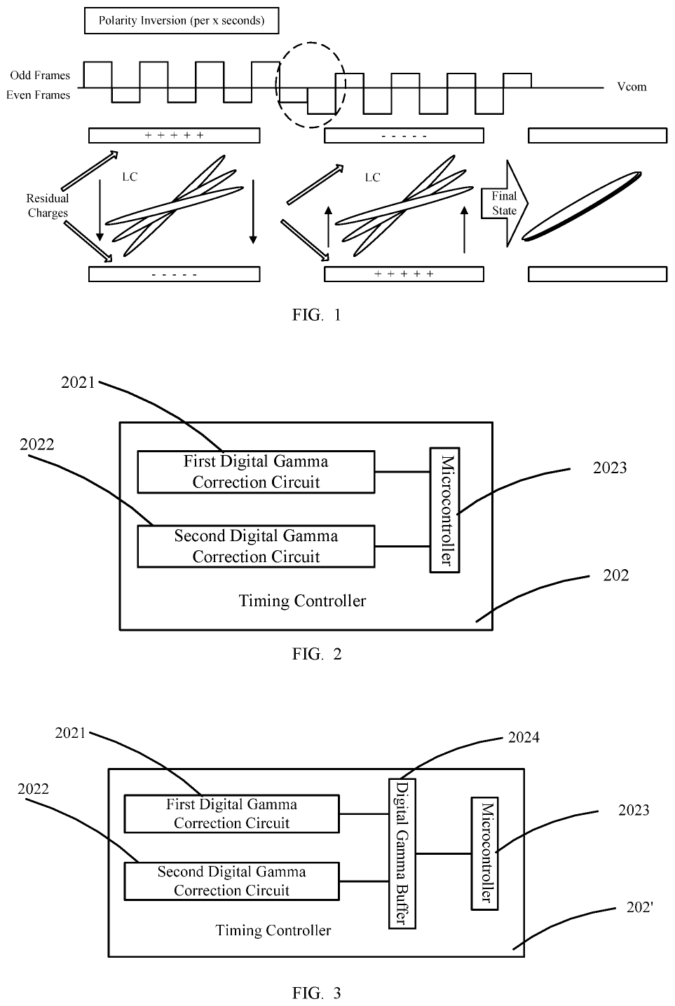

Regarding the DC residual problem mentioned above, it has been proposed to eliminate the DC residual by using a periodic polarity inversion in which the voltages of the odd frame and the even frame cancel each other. However, when there is an artifact, the voltage of the odd frame is not equal to the voltage of the even frame as shown in FIG. 1, so there will be residual charges when the polarity is inverted. In order to eliminate the residual charges, as shown in FIG. 1, the polarity of the data voltage of the last frame in one period of polarity inversion is set to be same as the polarity of the data voltage of the first frame in the next period of polarity inversion (as shown in the ellipse area in FIG. 1). In this way, the charges generated in a previous period of polarity inversion (e.g., positive charges) will be cancelled out by the charges (e.g., negative charges) in the next period of polarity inversion. However, the display panel will produce a flicker of visibility in this elliptical area due to a sudden change in voltage.

In view of this, embodiments of the present disclosure provide a timing controller. FIG. 2 is a schematic diagram of a timing controller according to an embodiment of the present disclosure. As shown in FIG. 2, the timing controller 202 includes a first digital gamma correction circuit 2021, a second digital gamma correction circuit 2022, and a microcontroller 2023. The microcontroller 2023 is configured to count output frames in response to receiving a video signal; determine, based on the counting, whether a current output frame needs to be data voltage polarity inverted; in response to determining that the current frame needs to be data voltage polarity inverted, calculate corrected data voltages using a first digital gamma correction table read from the first digital gamma correction circuit 2021; in response to determining that the current frame does not need to be polarity inverted, calculate corrected data voltages using a second digital gamma correction table read from the second digital gamma correction circuit 2022; and output the corrected data voltages to a display 201.

In an exemplary embodiment, determining, by the microcontroller, based on the counting, whether the current output frame needs to be data voltage polarity inverted may specifically include: determining, by the microcontroller, based on a preset polarity non-inversion period, whether the current frame is a frame that does not need to be data voltage polarity inverted.

Specifically, the micro control circuit 2023 counts the output frames based on the preset polarity non-inversion period. When the current frame is in the polarity non-inversion period, it is determined that the current frame needs to be data voltage polarity inverted; when the current frame is the last frame before proceeding to the next polarity non-inversion period, it is determined that the current frame does not need to be data voltage polarity inverted.

For example, in the case that a 60 Hz video signal is input, if the polarity non-inversion period is set to 28 s, the frame count in the polarity non-inversion period is 60 Hz×28 s=1680. Thus, the timing controller 202 can first calculate the corrected data voltages of the current frame using the first digital gamma correction table until the timing controller 202 detects the 1680-th frame, at which time the timing controller 202 uses the second digital gamma correction table to calculate the corrected data voltages for this frame. Thereafter, timing controller 202 will continue to calculate the corrected data voltages for the current frame using the first digital gamma correction table until the next 1680-th frame (i.e., n×1680, where n is a positive integer), and so on.

In an exemplary embodiment, the second digital gamma correction table may be a Flash DGA (ACC) Table, where DGA represents Digital Gamma adjusted, i.e., digital gamma correction, and ACC represents Accurate Color Calibration, i.e., accurate color correction. The second digital gamma correction table can be obtained by pre-adjusting the data voltages so that the frame that does not need to be data voltage polarity inverted is consistent in brightness with the two frames before and after. For example, the values in the Flash DGA (ACC) Table can be pre-adjusted to perform brightness correction on the flickering frame until the periodic visibility flicker is not visible or falls below a threshold.

In an example embodiment, the first digital gamma correction table may be a Normal DGA (ACC) Table, typically a DGA (ACC) table. The first digital gamma correction table can be obtained by pre-adjusting the data voltages to achieve a specified display effect. For example, the values in the Normal DGA (ACC) Table can be adjusted in advance to fine-tune the 256-gray gamma to correct the color temperature under white, thus achieving a desired display effect.

If the timing controller 202 determines that the current frame needs to be data voltage polarity inverted, the timing controller 202 calculates the corrected data voltages according to the Normal DGA (ACC) Table that has been normally gamma corrected, and outputs the calculated corrected data voltages to the display 201 so that the display 201 displays a corresponding image.

If the timing controller 202 determines that the current output frame does not need to be data voltage polarity inverted, since the display panel itself has DC residual that causes a difference of its brightness from the normal DGA output grayscale brightness, the timing controller 202 uses the Flash DGA (ACC) Table to calculate the corrected data voltages to ensure that the brightness of the successive images is consistent, thereby reducing or eliminating periodic flicker.

Compared to a conventional timing controller, the timing controller of the embodiment of the present disclosure is provided with the second digital gamma correction circuit 2022 that stores the second digital gamma correction table obtained by pre-adjusting the data voltages to keep the brightness of the current frame that does not need to be polarity inverted consistent with the brightness of the two frames before and after. When the timing controller 202 determines that the current output frame does not need to be data voltage polarity inverted, the second digital gamma correction table is used to calculate the corresponding corrected data voltages, thereby ensuring that there is no noticeable flicker at the frame that is not polarity inverted.

FIG. 3 is a schematic diagram of another timing controller in accordance with an embodiment of the present disclosure. As shown in FIG. 3, a timing controller 202′ additionally includes a digital gamma buffer 2024 as compared to the timing controller 202 shown in FIG. 2. The data gamma buffer 2024 is configured to read the first digital gamma correction table from the first digital gamma correction circuit 2021 and the second digital gamma correction table from the second digital gamma correction circuit 2022, respectively, and to buffer the first digital gamma correction table and second digital gamma correction table.

In this embodiment, the microcontroller 2023 reads the pre-buffered first digital gamma correction table or the second digital gamma correction table from the digital gamma buffer 2024, thereby speeding up the rate at which the microcontroller 2023 reads the digital gamma correction tables.

The remaining portions of the timing controller 202′ are similar to those of the timing controller 202 and will not be repeated again herein.

Compared to a conventional timing controller, the timing controller of the embodiment of the present disclosure is provided with the second digital gamma correction circuit 2022 that stores the second digital gamma correction table obtained by pre-adjusting the data voltages to keep the brightness of the current frame that does not need to be data voltage polarity inverted consistent with the brightness of the two frames before and after. When the timing controller 202 determines that the current output frame does not need to be data voltage polarity inverted, the second digital gamma correction table is used to calculate the corresponding corrected data voltages, thereby ensuring that there is no noticeable flicker at the frame that is not polarity inverted.

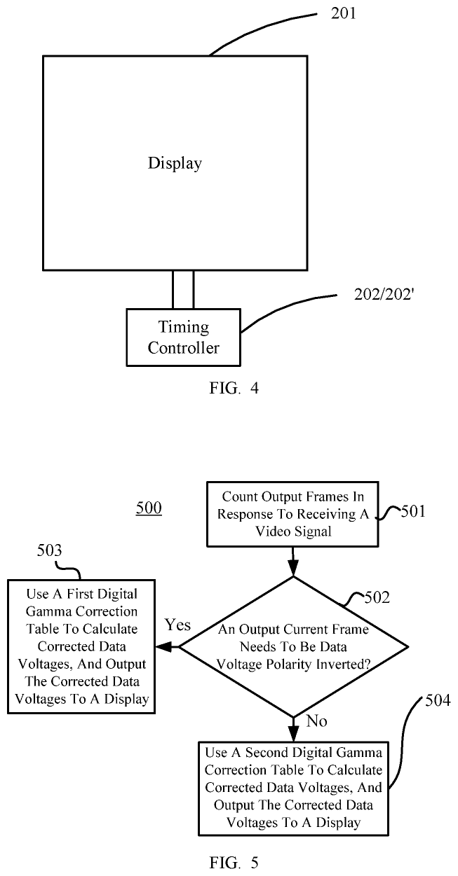

FIG. 4 is a schematic diagram of a display device in accordance with an embodiment of the present disclosure. As shown in FIG. 4, the display device includes a display 201 and a timing controller 202 as shown in FIG. 2 or 3. The display 201 is configured to display an image based on the received corrected data voltages.

Compared to a conventional timing controller, the timing controller in the display device of the embodiment of the present disclosure is provided with the second digital gamma correction circuit 2022 that stores the second digital gamma correction table obtained by pre-adjusting the data voltages to keep the brightness of the current frame that does not need to be data voltage polarity inverted consistent with the brightness of the two frames before and after. When the timing controller 202 determines that the current output frame does not need to be data voltage polarity inverted, the second digital gamma correction table is used to calculate the corresponding corrected data voltages, thereby ensuring that there is no noticeable flicker at the frame that is not polarity inverted.

FIG. 5 is a flowchart 500 of a display driving method utilizing any of the timing controllers described above, in accordance with an embodiment of the present disclosure. As shown in FIG. 5, at step 501, the output frames are counted in response to receiving a video signal. Next, at step 502, it is determined whether the current output frame needs to be data voltage polarity inverted based on the counting. If it is determined that the current frame needs to data voltage polarity inverted, the method proceeds to step 503. If it is determined that the current frame does not need to be data voltage polarity inverted, the method proceeds to step 504. At step 503, the corrected digital voltages are calculated using the first digital gamma correction table and the corrected data voltages are output to the display. At step 504, the corrected digital voltages are calculated using the second digital gamma correction table and the corrected data voltages are output to the display.

In an exemplary embodiment, determining whether the current output frame needs to be data voltage polarity inverted based on the counting may specifically include: determining whether the current frame is a frame that does not need to be data voltage polarity inverted based on a preset polarity non-inversion period.

Specifically, the output frames can be counted based on the preset polarity non-inversion period. When the current frame is in the polarity non-inversion period, it is determined that the current frame needs to be data voltage polarity inverted; when the current frame is the last frame before proceeding to the next polarity non-inversion period, it is determined that the current frame does not need to be data voltage polarity inverted.

For example, in the case that a 60 Hz video signal is input, if the polarity non-inversion period is set to 28 s, the frame count in the polarity non-inversion period is 60 Hz×28 s=1680. Thus, the corrected data voltages of the current frame can be calculated first using the first digital gamma correction table until the 1680-th frame, at which time the second digital gamma correction table is used to calculate the corrected data voltages for this frame. Thereafter, the first digital gamma correction table is again used to calculate the corrected data voltages for the current frame until the next 1680-th frame (i.e., n×1680, where n is a positive integer), and so on.

In an exemplary embodiment, the second digital gamma correction table may be a Flash DGA (ACC) Table, where DGA represents Digital Gamma adjusted, i.e., digital gamma correction, and ACC represents Accurate Color Calibration, i.e., accurate color correction. The second digital gamma correction table can be obtained by pre-adjusting the data voltages so that the frame that does not need to be data voltage polarity inverted is consistent in brightness with the two frames before and after. For example, the values in the Flash DGA (ACC) Table can be pre-adjusted to perform brightness correction on the flickering frame until the periodic visibility flicker is not visible or falls below a threshold.

In an example embodiment, the first digital gamma correction table may be a Normal DGA (ACC) Table, typically a DGA (ACC) table. The first digital gamma correction table can be obtained by pre-adjusting the data voltages to achieve a specified display effect. For example, the values in the Normal DGA (ACC) Table can be adjusted in advance to fine-tune the 256-gray gamma to correct the color temperature under white, thus achieving a desired display effect.

If it is determined that the current frame needs to be data voltage polarity inverted, the corrected data voltages are calculated according to the Normal DGA (ACC) Table that has been normally gamma corrected, and the calculated corrected data voltages are output to the display 201 so that the display 201 displays a corresponding image.

If it is determined that the current output frame does not need to be data voltage polarity inverted, since the display panel itself has DC residual that causes a difference of its brightness from the normal DGA output grayscale brightness, the Flash DGA (ACC) Table is used to calculate the corrected data voltages to ensure that the brightness of the successive images is consistent, thereby reducing or eliminating periodic flicker.

Compared to a conventional display driving method, the display driving method of the embodiment of the present disclosure utilizes the second digital gamma correction circuit that stores the second digital gamma correction table obtained by pre-adjusting the data voltages to keep the brightness of the current frame that does not need to be polarity inverted consistent with the brightness of the two frames before and after. When it is determined that the current output frame does not need to be data voltage polarity inverted, the second digital gamma correction table is used to calculate the corresponding corrected data voltages, thereby ensuring that there is no noticeable flicker at the frame that is not polarity inverted.

It will be understood by those skilled in the art that all or part of the steps in the above method may be performed by a program instructing relevant hardware. The program may be stored in a computer readable storage medium such as a read only memory, a magnetic disk or an optical disk. Alternatively, all or part of the steps of the above embodiment may also be implemented using one or more integrated circuits. Accordingly, each of the circuits in the foregoing embodiments may be implemented in hardware, or may be implemented in software function modules. The present disclosure is not limited to any specific form of combination of hardware and software.

The foregoing is merely example embodiments of the present disclosure. Of course, there are other various embodiments of the present disclosure. Various changes and modifications can be made by a person skilled in the art in accordance with the present disclosure without departing from the spirit and scope of the disclosure, which changes and modifications should be encompassed in the scope of the appended claims of the present disclosure.

1. A timing controller, comprising: a first digital gamma correction circuit, a second digital gamma correction circuit, and a microcontroller, wherein the microcontroller is configured to
count output frames in response to receiving a video signal;
determine, based on the counting, whether a current output frame needs to be data voltage polarity inverted;
responsive to a determination that the current output frame needs to be data voltage polarity inverted, using a first digital gamma correction table read from the first digital gamma correction circuit to calculate corrected data voltages;
responsive to a determination that the current output frame does not need to be polarity inverted, using a second digital gamma correction table read from the second digital gamma correction circuit to calculate corrected data voltages; and
output the corrected data voltages to a display.

2. The timing controller of claim 1, wherein the second digital gamma correction table is obtained by pre-adjusting data voltages so that the current output frame that does not need to be data voltage polarity inverted is consistent in brightness with two frames before and after.

3. The timing controller of claim 1, wherein the first digital gamma correction table is obtained by pre-adjusting data voltages to achieve a specified display effect.

4. The timing controller of claim 1, further comprising a digital gamma buffer configured to read the first digital gamma correction table from the first digital gamma correction circuit and the second digital gamma correction table from the second digital gamma correction circuit, respectively, and to buffer the first digital gamma correction table and second digital gamma correction table.

5. The timing controller of claim 4, wherein the microcontroller is further configured to read the first digital gamma correction table or the second digital gamma correction table from the digital gamma buffer.

6. The timing controller of claim 1, wherein the microcontroller is configured to determine whether the current frame is a frame that does not need to be data voltage polarity inverted based on a preset polarity non-inversion period.

7. A display device, comprising a display and the timing controller as claimed in claim 1, wherein the display is configured to display an image based on received corrected data voltages.

8. A display driving method, comprising:
counting output frames in response to receiving a video signal;
determining, based on the counting, whether a current output frame needs to be data voltage polarity inverted;
responsive to a determination that the current output frame needs to be data voltage polarity inverted, using a first digital gamma correction table read from a first digital gamma correction circuit to calculate corrected data voltages;
responsive to a determination that the current output frame does not need to be polarity inverted, using a second digital gamma correction table read from a second digital gamma correction circuit to calculate corrected data voltages; and
outputting the corrected data voltages to a display.

9. The driving method of claim 8, further comprising obtaining the second digital gamma correction table by pre-adjusting data voltages so that the frame that does not need to be data voltage polarity inverted is consistent in brightness with two frames before and after.

10. The driving method of claim 8, further comprising obtaining the first digital gamma correction table by pre-adjusting data voltages to achieve a specified display effect.

11. The driving method of claim 8, further comprising:
reading the first digital gamma correction table from the first digital gamma correction circuit;
reading the second digital gamma correction table from the second digital gamma correction circuit; and
buffering the first digital gamma correction table and second digital gamma correction table.

12. The driving method of claim 11, further comprising:
reading the buffered first digital gamma correction table or second digital gamma correction table.

13. The driving method of claim 8, wherein the determining comprises:
determining, based on a preset polarity non-inversion period, whether the current frame is a frame that does not need to be data voltage polarity inverted.

14. The timing controller of claim 2, wherein the microcontroller is configured to determine whether the current frame is a frame that does not need to be data voltage polarity inverted based on a preset polarity non-inversion period.

15. The timing controller of claim 3, wherein the microcontroller is configured to determine whether the current frame is a frame that does not need to be data voltage polarity inverted based on a preset polarity non-inversion period.

16. The timing controller of claim 4, wherein the microcontroller is configured to determine whether the current frame is a frame that does not need to be data voltage polarity inverted based on a preset polarity non-inversion period.

17. The timing controller of claim 5, wherein the microcontroller is configured to determine whether the current frame is a frame that does not need to be data voltage polarity inverted based on a preset polarity non-inversion period.

18. The driving method of claim 9, wherein the determining comprises:
determining, based on a preset polarity non-inversion period, whether the current frame is a frame that does not need to be data voltage polarity inverted.

19. The driving method of claim 10, wherein the determining comprises:
determining, based on a preset polarity non-inversion period, whether the current frame is a frame that does not need to be data voltage polarity inverted.

20. The driving method of claim 11, wherein the determining comprises:
determining, based on a preset polarity non-inversion period, whether the current frame is a frame that does not need to be data voltage polarity inverted.
